(19) United States
(12) Patent Application Publication
(10) Pub. No.: US 2025/0024579 A1
(43) Pub. Date: Jan. 16, 2025

(54) METHOD AND DEVICE FOR GENERATING ISOLATED ULTRASHORT ELECTROMAGNETIC PULSES

(71) Applicants: COMMISSARIAT A L’ENERGIE ATOMIQUE ET AUX ENERGIES ALTERNATIVES, PARIS (FR); CENTRE NATIONAL DE LA RECHERCHE SCIENTIFIQUE, PARIS (FR); ECOLE POLYTECHNIQUE, PALAISEAU Cedex (FR); ECOLE NATIONALE SUPERIEURE DE TECHNIQUES AVANCEES, PALAISEAU Cedex (FR)

(72) Inventors: Henri VINCENTI, GIF SUR YVETTE (FR); Adrien LEBLANC, PALAISEAU (FR)

(21) Appl. No.: 18/715,067

(22) PCT Filed: Dec. 16, 2022
(86) PCT No.: PCT/EP2022/086471

§ 371 Date: May 30, 2024

(30) Foreign Application Priority Data
Dec. 23, 2021 (FR) 2114379

(51) Int. Cl. H05G 2/00

(52) U.S. Cl. CPC H05G 2/0086

(57) ABSTRACT

A method for generating isolated ultra-short electromagnetic pulses, includes the following steps: directing onto a surface of a target in the condensed state a first laser pulse at an oblique angle of incidence and with p-polarization, the first laser pulse having a normalized peak amplitude greater than or equal to 1, whereby a plasma mirror oscillating at relativistic velocity is generated on the surface of the target; and directing onto the surface of the target, in correspondence with the plasma mirror, a second laser pulse of duration shorter than or equal to the optical period of the first pulse, the second laser pulse being spatially and temporally superposed with the first laser pulse; whereby the second laser pulse, reflected by the plasma mirror, undergoes a shift of its wavelength and a modification of its duration.

### CROSS-REFERENCE TO RELATED APPLICATIONS

This application is a National Stage of International patent application PCT/EP2022/086471, filed on Dec. 16, 2022, which claims priority to foreign French patent application No. FR 2114379, filed on Dec. 23, 2021, the disclosures of which are incorporated by reference in their entireties.

### FIELD OF THE INVENTION

The invention relates to a method and an apparatus for generating high-energy isolated ultra-short coherent electromagnetic pulses. It relates in particular, but not exclusively, to the generation of pulses with a sub-picosecond (1 ps=10-12 s), sub-femtosecond (1 fs=10-15 s) or “attosecond” (1 as =10-18 s) duration and an energy typically between 1 mJ and 1 J. Such pulses lend themselves to many applications, from deep-ultraviolet (DUV) or extreme-ultraviolet (XUV or EUV: 10-200 nm) lithography, used in the fabrication of integrated circuits, to fundamental research (study of ultra-fast processes in matter, etc.) and eye surgery.

### BACKGROUND

At the present time, several technologies allow electromagnetic pulses to be generated the spectrum of which lies, in whole or in part, in the domain of the DUV (200 nm-400 nm), of the extreme ultraviolet or even in the X-rays (wavelength shorter than 10 nm).

Excimer lasers use a gas of molecules in a cavity that is pumped by an electric discharge. The discharge excites the molecules, which on de-excitation emit coherent radiation in the ultraviolet. Depending on the gas used in the cavity, UV radiation ranging from 351 nm (XeF) to 157 nm (F₂) may be produced. At the current time, excimer lasers are able to produce nanosecond pulses with a repetition rate of the order of one kHz with an energy per pulse of 1 mJ to 100 mJ (corresponding to average powers of about 1 W to 100 W). Their energy efficiency is of the order of 0.3%. This technology is widely used in DUV lithography. Its main drawback is that the minimum achievable wavelength remains relatively long (157 nm), thus limiting the minimum size of the patterns producible. Furthermore, it does not allow ultra-short pulses, i.e. pulses with a duration (full width at half maximum) shorter—and often much shorter—than 100 ps, or even 100 fs, to be obtained.

Hot plasmas (˜6000 K) created by focusing an intense (typically CO₂) laser on matter emit thermal radiation extending to the extreme ultraviolet. These sources allow very short wavelengths, of the order of 10 nm, to be reached with an average power of the order of 100 W and an energy conversion efficiency of about 0.3%. This technology is widely used in EUV lithography, particularly for 13.5 nm patterns. However it has major drawbacks: the light generated is incoherent and therefore difficult to manipulate; the hot plasma also emits energetic particles (electrons and ions) that damage the EUV optics; the technology is very expensive and consumes a lot of power. Furthermore, it does not allow ultra-short coherent pulses to be obtained.

Free electron lasers (FELs) use a linear accelerator to accelerate bunches of electrons to high energies (100 MeV-several tens of GeV) and make them oscillate in an undulator composed of a series of magnets (or coils) that deliver a strong magnetic field. This oscillating motion produces synchrotron radiation in the UV, EUV and X-ray domain, which is amplified by wave-electron coupling (laser effect). These lasers produce coherent pulses that are ultra-short (a few femtoseconds) and of relatively high energy (a few tens of μJ). The main drawbacks of FELs are their extremely high cost and modest efficiency, which limits them to fundamental research. Furthermore, they do not allow pulses of attosecond duration to be obtained (by “attosecond pulses” what is meant is pulses of duration shorter than 1 fs).

High-harmonic generation (HHG) is a technique that consists in focusing femtosecond laser pulses, generally in the near infrared, of relatively high intensity (typically ˜10¹⁵ W/cm²), on a gas to obtain the emission of harmonic radiation from the laser, the harmonic orders potentially being as high as several tens. In the time domain, the harmonic radiation takes the form of trains of attosecond pulses, but in certain cases it is possible to obtain isolated attosecond pulses. The typical efficiencies obtained (infrared to UV to EUV) are of the order of 10⁻⁵ to 10⁻⁶ over the range 10 eV to 100 eV (i.e. 120 nm to 12 nm). At the current time, this type of source is realized with infrared and near-infrared lasers of a few mJ to a few tens of mJ, this allowing at best UV/EUV pulses of about ten μJ of energy to be achieved. This type of EUV light source is relatively inexpensive, but remains above all used in time-resolved fundamental physics experiments. The performance in terms of energy of this type of apparatus is very poor, this making them unsuitable for industrial applications.

Other techniques, exploiting reflection of laser pulses from dense plasmas (“plasma mirrors”) are less mature.

The technique of generation of harmonics on a relativistic plasma mirror-see for example (Vincenti 2019)—consists in focusing an intense femtosecond infrared or near-infrared laser, with high temporal contrast and a power from a few tens of TW to a few tens of PW, to achieve laser intensities I>10¹⁸ W/cm² on an initially solid target. At the focal point, the laser completely ionizes the target and forms a dense plasma, which is reflective to the incident field. Under the effect of this field, the “plasma mirror” thus formed oscillates at relativistic speeds at the laser period. These oscillations lead to periodic temporal compression of the incident field which corresponds, in the frequency domain, to a spectrum of high-order Doppler harmonics of the laser frequency, which may extend to the EUV or even X-ray range, and in the time domain to a train of attosecond pulses. The conversion efficiencies obtained depend strongly on the laser conditions (intensity, angle of incidence) and plasma conditions (density, length of the vacuum-plasma interface). Under optimized conditions and for lasers of 100-TW class (˜2 J-20 fs, max intensity of the order of 1019 W/cm²) conversion efficiencies are less than 10⁻⁴ below 80 nm (i.e. energies of the order of 100 μJ). For lasers of multi-PW class (100 J-20 fs, intensities I>1020 W/cm²) these conversion efficiencies are of the order of 0.5% at 80 nm (i.e. energies of the order of one joule). These efficiencies decrease according to a power law with frequency, and therefore quickly become negligible at short wavelengths. This technology is currently at the stage of experimental proof of concept by a few large laser laboratories at the global cutting edge in the field. It is not yet used for industrial purposes.

The relativistic-flying-mirror technique exists only as a theoretical concept. It consists in focusing a very intense infrared first laser on a gas-(Bulanov 2003)—or on a thin solid sheet-(Tamburini 2014)—of a few tens of nm in thickness to generate a relativistic plasma mirror. A second counter-propagating laser is then focused on the mirror generated by the first pulse, so as to compress it temporally and shorten its wavelength via the Doppler effect. For example, in the case of a thin sheet, a first very intense (multi-PW) laser beam is focused (I>1023 W/cm²) on one side of the sheet so as to accelerate the ions and electrons of the sheet through radiation pressure and create a relativistic mirror. A second laser beam propagating counter to the mirror is delivered to the other side of the sheet. The laser beam reflected by the sheet is then temporally compressed and converted by the Doppler effect to the UV/EUV. Unlike the generation of harmonics on relativistic plasma mirrors, this technique should allow isolated femtosecond or attosecond pulses to be generated. Unfortunately, the accessible conversion efficiencies and minimum UV/EUV wavelengths remain very limited. In (Tamburini 2014), the authors mention a minimum wavelength of about 570 nm from a laser at 800 nm with conversion rates (infrared toward 570 nm) of less than 1%. One of the main limitations of the proposed techniques is that they do not allow, under realistic conditions, a mirror to be obtained that is of sufficient optical quality (density, area) to be able to adequately reflect the second pulse. Moreover, these techniques are extremely complex to implement experimentally because they require two ultra-short high-power laser pulses to be synchronized in space and time on a femtosecond time scale and a micron-sized spatial scale, all to achieve low efficiencies, even in the ideal case. It therefore does not seem very likely that this technique could be implemented for industrial purposes.

### SUMMARY OF THE INVENTION

The invention aims to overcome, in whole or in part, the aforementioned drawbacks of the prior art. More particularly, it aims to generate coherent and ultra-short isolated electromagnetic pulses, the spectrum of which may extend wholly or partly into the DUV, EUV or even X-ray domains, that have an energy greater than or equal to 1 mJ. No prior-art technique allows such a result to be obtained. Moreover, the invention aims to generate these pulses in a manner that is relatively simple to implement, and that is therefore suitable for industrial applications.

According to the invention, this goal is reached using a first intense laser pulse (the “generator pulse”) to generate an oscillating relativistic plasma mirror, from which a second laser pulse (the “source pulse”) is reflected. The source pulse has a duration (full width at half maximum) shorter than or equal to the optical period of the generator pulse, and preferably shorter than half of this optical period. Since the relativistic plasma mirror oscillates at the frequency of the first pulse, the source pulse does not see an oscillating mirror, but a mirror moving monotonically, at a relativistic speed (or, at the very most, making a single back-and-forth motion). By choosing the temporal shift between the first and second pulses appropriately, the source pulse will be reflected by the plasma mirror while the latter is moving at an almost constant relativistic speed in a direction counter the propagation of this pulse. The source pulse then sees its wavelength decreased (“blue shift”) via the Doppler effect and a strong temporal compression.

The technique of the invention is much easier to implement than the relativistic-flying-mirror technique, because it does not require the two pulses to be counter-propagating. On the contrary, it is preferable for them to propagate coaxially, this greatly simplifying the optical setup. Moreover, the two pulses may be obtained from the same initial laser pulse, this ensuring their synchronization. Furthermore, the optical quality of the plasma mirror thus obtained is much better than that of a relativistic flying mirror.

With respect to the relativistic-plasma-mirror technique, in which a single laser pulse generates the plasma and is reflected therefrom, the invention allows a much better conversion efficiency to the DUV/EUV to be obtained. Specifically, the invention makes it possible in principle to convert almost all of the energy of the source pulse to short wavelengths, whereas in the case of the prior art only a small fraction of this energy was converted. In fact, in certain cases the invention allows a conversion efficiency greater than 1 to be achieved (relative to the energy of the source pulse), because the source pulse acquires energy from the plasma mirror when it is reflected.

Furthermore, the invention allows single ultra-short pulses (with durations as long as a few tens of attoseconds) to be obtained, whereas the relativistic-plasma-mirror technique generates trains of such pulses. At the present time, other techniques, such as high-harmonic generation (HHG) in gases, allow isolated attosecond pulses to be generated, but only with very low energies and conversion efficiencies (nanojoules, efficiencies of the order of 10⁻⁶ for HHG).

As will be explained in more detail below, the invention can already be implemented using existing and proven technologies.

One subject of the invention is therefore a method for generating isolated ultra-short electromagnetic pulses, comprising the following steps:
directing onto a surface of a target in the condensed state a first laser pulse at an oblique angle of incidence and with p-polarization, said first laser pulse having a first wavelength, corresponding to a first optical period, and a normalized peak amplitude greater than or equal to 1, whereby a plasma mirror oscillating at relativistic velocity is generated on the surface of the target; and
directing onto said surface of the target, in correspondence with said plasma mirror, a second laser pulse having a second wavelength, shorter than the first wavelength, and a duration shorter than or equal to the first optical period, the second laser pulse being spatially and temporally superposed with the first laser pulse;
whereby the second laser pulse, reflected by the plasma mirror, undergoes a shift of its wavelength and a modification of its duration.

Another subject of the invention is an apparatus for generating isolated ultra-short electromagnetic pulses, comprising:
a laser system configured to generate a first laser pulse having a first wavelength corresponding to a first optical period and a second laser pulse having a second wavelength, shorter than the first wavelength, and a duration shorter than or equal to the first optical period;
an optical system configured to:
   direct onto a surface of a target in the condensed state the first laser pulse, at an oblique angle of incidence and with a p-polarization;
direct onto said surface of the target the second laser pulse, such that it is spatially and temporally superposed with the first laser pulse;
the laser system and the optical system also being configured such that the first laser pulse has, on the surface of the target, a normalized peak amplitude greater than or equal to 1.

### BRIEF DESCRIPTION OF THE DRAWINGS

Other features, details and advantages of the invention will become apparent on reading the description given with reference to the appended drawings, which are given by way of example, and which show, respectively:

FIG. 1, a conceptual schematic of a method according to one embodiment of the invention;

FIG. 2, the first and second laser pulses and the main parameters characterizing these pulses;

FIG. 3A, a graph of the second laser pulse positioned with respect to an optical cycle of the first laser pulse;

FIG. 3B, the spectra of the first and second laser pulses;

FIG. 3C, obtained from a simplified simulation, a graph of the second laser pulse positioned with respect to an optical cycle of the first laser pulse after reflection by the plasma mirror;

FIG. 3D, the spectra of the pulses of FIG. 3C;

FIG. 4A, obtained from a first-principles simulation, a graph of a second laser pulse before and after reflection by a plasma mirror;

FIG. 4B, the spectra of the pulses of FIG. 4A; and

FIG. 5, a conceptual schematic of an apparatus according to one embodiment of the invention.

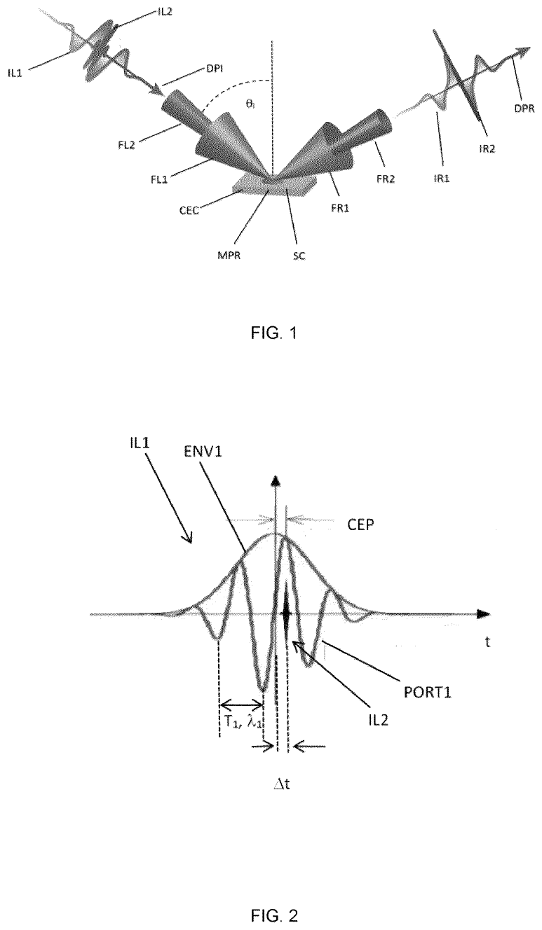

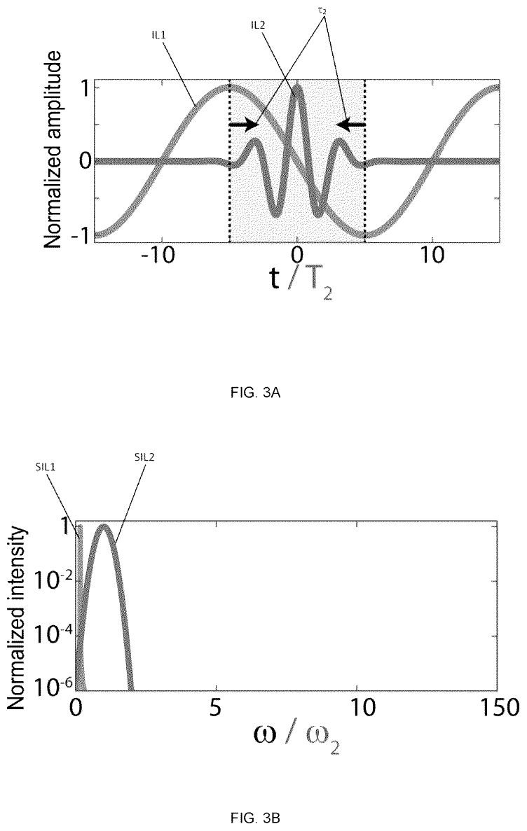

FIG. 1 and FIG. 2 illustrate the principle underlying the invention.

### DETAILED DESCRIPTION

A first laser beam FL1 bearing a generator laser pulse IL1 and a second laser beam FL2 bearing a source pulse IL2 propagate in a common propagation direction DPI making an angle θᵢ—strictly smaller than 90°—to the normal to the surface SC of a target solid CEC (and more generally a target in the condensed state, the use of a liquid target also being possible). The chemical nature of the target is of secondary importance, because the target is only intended to generate a non-equilibrium plasma in which the movement of ions may be ignored to a first approximation and only the movement of electrons is really important.

The generator laser pulse IL1 has a wavelength λ₁ (and therefore an optical period T₁) that is typically in the infrared range.

The laser beam FL1 is focused on the target with an intensity sufficient to generate a relativistic plasma mirror. Typically, this condition is met when the pulse has a normalized peak amplitude a₁ greater than or equal to 1, the normalized amplitude being defined by

$${a}_{1} = \frac{{eE}_{L}}{{m}_{e} {ω}_{1} c}$$

where e and me are the charge and mass of the electron, respectively, E_{L} is the peak amplitude of the pulse (expressed in V/m), ω₁ is the angular frequency of the laser, and c is the speed of light. For a wavelength λ₁=3 μm, a₁=1 corresponds to an intensity of about 1.5×10¹⁷ W/cm².

Since the laser pulse IL1 is p-polarized, the component of the electric field perpendicular to the surface makes the electrons of the plasma oscillate with a period T₁ and with a relativistic peak velocity. Provided that the electron density ne of the

$${ω}_{p} = \sqrt{\frac{{n}_{e} {e}^{2}}{m {ε}_{0}}}$$

plasma is such that the plasma frequency (ε₀ being the electric permittivity of free space) is greater than the frequency—ω₂—of the source pulse IL2, a relativistic plasma mirror MPR is obtained from which said source pulse IL2 is reflected. This condition is met for source pulses IL2 in the near infrared or visible (or even in the near or mid ultraviolet) if the target is in the condensed state (solid or liquid target) and if the amplitude of the field of the pulse IL1 is sufficiently high.

For the component of the electric field of IL1 perpendicular to the surface of the target to have a sufficient amplitude, the angle of incidence θᵢ must preferably be larger than or equal to 25°. Furthermore, it is preferable for θᵢ not to exceed 75° to prevent the focal spot from spreading over the target too much and reducing the amplitude of the electric field.

The source pulse IL2 has a duration T₂ (defined at the intensity FWHM, FWHM standing for Full Width at Half Maximum) that is shorter than the optical period T₁ of the generator pulse (this necessarily meaning that the wavelength λ₂ and the optical period T₂ of the source pulse are less than λ₁ and T₁, respectively). Preferably, the duration T₂ is shorter than or equal to T₁/2 (and consequently λ2<λ₁/2). If the delay Δt between the two pulses (more precisely, the delay between the peaks of their envelopes) and the phase CEP of the carrier PORT1 of the generator pulse IL1 relative to its envelope ENV1 (i.e. the carrier-envelope phase) are appropriately chosen, the source pulse IL2 “sees” a plasma mirror having a velocity component that is approximately constant in the direction counter to its direction of propagation DPI.

According to one preferred embodiment of the invention, Δt and CEP are chosen such that the plasma mirror moves away from the surface (moves toward free space) throughout the duration of the source pulse. Therefore, the pulse IR2 obtained by reflection of the source pulse will undergo a “blue” shift (i.e. a shift to shorter wavelengths) and a temporal compression, and in certain cases amplification through transfer of energy from the generator pulse via the plasma mirror. The generator pulse will also be reflected by the plasma mirror MPR; it will undergo spectral broadening and deformation of its temporal profile (in [FIG. 1] the reference IR1 designates the reflected generator pulse). The two reflected pulses IR1 and IR2 propagate along the same propagation direction DPR and are superposed spatially and temporally; however, their spectra are sufficiently different that it is possible to separate them, by filtering or exploiting the fact that IR2 diverges more than IR1 due to its longer wavelength (as will be explained below, it is also possible to use a generator pulse and a source pulse having orthogonal polarizations, this also making it possible to separate the pulses IR1 and IR2 by means of a polarizer).

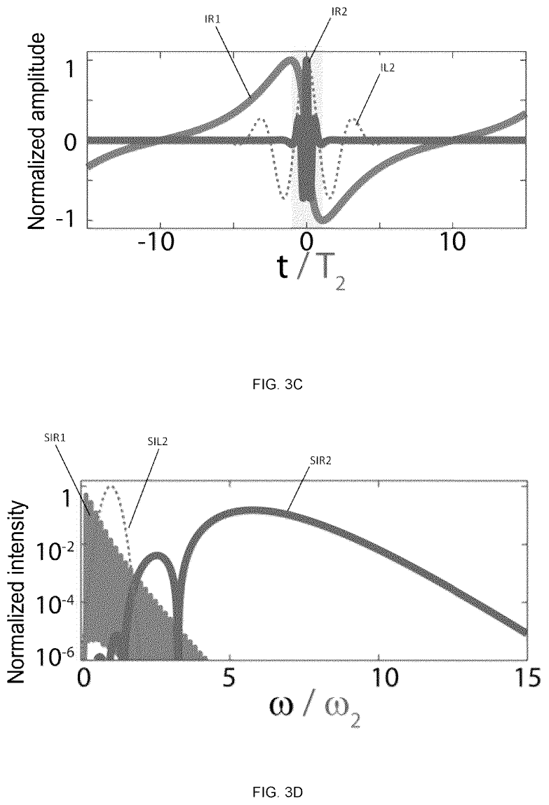

FIG. 3A is an idealized graph of the electric field of the source pulse IL2 and of 1.5 optical cycles of the pulse IL1. The source pulse IL2 is a pulse of a single optical cycle (T₂=T₂) and its wavelength λ₂ is shorter than λ₁ by a factor of 6. [FIG. 3B] is a graph of the spectra SIL2, SIL1 of these two pulses. [FIG. 3C] is an idealized graph of the electric field of the reflected pulses IR1 (over a fraction of its duration) and IR2. [FIG. 3D] is a graph of the spectra SIR2, SIR1 of these two pulses. Comparison of [FIG. 3A] and [FIG. 3C] allows the temporal compression of the source pulse to be seen, and comparison of [FIG. 3B] and [FIG. 3D] allows the broadening and “blue” shift of its spectrum to be seen. In these figures, the spectra have been shown as a function of angular frequency ω normalized to ω₂, the angular frequency of the source pulse.

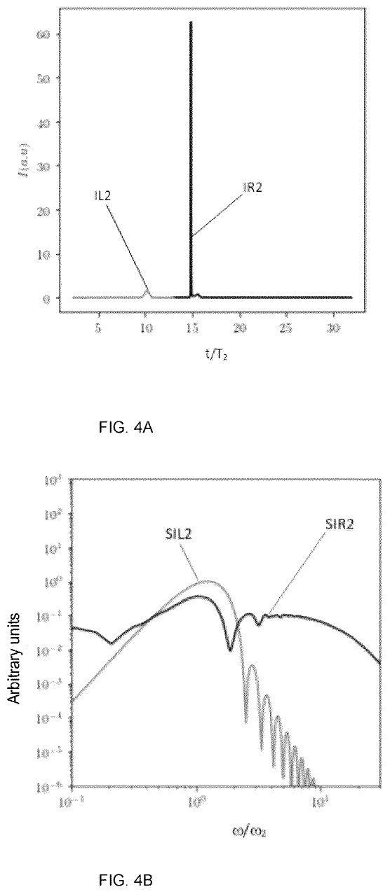

While the preceding figures were obtained using a simplified model (perfectly reflecting mirror oscillating at the period of the generator pulse), [FIG. 4A] and [FIG. 4B] illustrate the results of a first-principles kinetic particle-in-cell (PIC) simulation of reflection of a near-infrared laser (λ₂=1 μm) from a relativistic plasma mirror accelerated by a laser emitting in the mid-infrared (λ₁=3 μm). The normalized laser amplitude is a₁=7 for the generator pulse and a₂=1 for the source pulse. The simulations indicate that the source pulse reflected by the plasma mirror, IR2, is temporally compressed from an initial duration of 3.3 fs (i.e. one optical cycle expressed in terms of intensity FWHM)—curve IL2—to a duration of 80 as (intensity FWHM). The intensity of the reflected pulse is more than 60 times greater than that of the incident source pulse and contains 2.6 times more energy than it, this additional energy being transferred from the generator pulse via the movement of the relativistic plasma mirror. The spectrum of the reflected pulse, SIR2, is spectrally far broader than the spectrum—SIL2—of the initial pulse and extends from a few nanometers (X-rays) to 1 μm. It is flat over a good part of the spectral range, giving very high generation efficiencies. About 30% of the initial energy is below 100 nm, i.e. in the EUV and X-ray spectral regions.

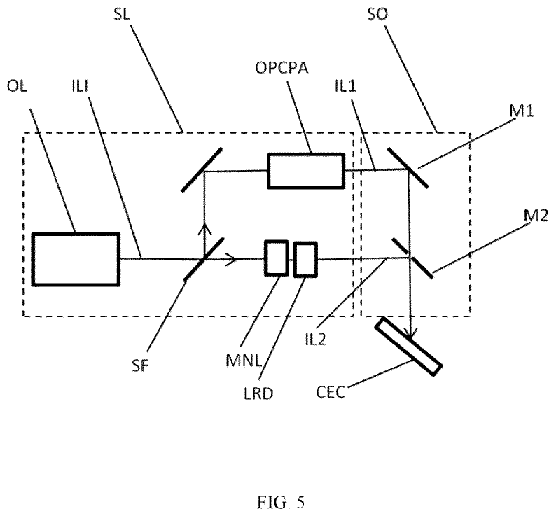

FIG. 5 illustrates an apparatus for generating isolated ultra-short electromagnetic pulses according to one embodiment of the invention. This apparatus is mainly made up of a laser system SL for generating the generator and source pulses IL1 and IL2, and of an optical system SO for directing these pulses onto a target CEC in the condensed state.

The laser system SL comprises a laser oscillator OL that delivers laser pulses called initial laser pulses IL1, which are typically of femtosecond or picosecond duration, generally in the near- or mid-infrared. A beam splitter SF splits these pulses into two components. It is advantageous for the laser oscillator to have a stabilized carrier-envelope phase (CEP), this being achievable using techniques known in the art. Specifically, the source pulse is reflected from the plasma mirror during a determined fraction of the optical cycle of the generator pulse. It is therefore very important for the position of the field under the envelope of the generator pulse to be identical each time a shot is fired. This parameter is given by the CEP of the generator pulse, which in turn depends on the CEP of the initial pulse. It will be noted that the CEP of the source pulse is not, per se, an important parameter to control.

A first component of each pulse is converted to longer wavelengths and amplified by an amplifying device such as an optical parametric chirped-pulse amplifier (OPCPA) to form a generator pulse IL1; by way of example (von Grafenstein 2020) describes an OPCPA operating in the mid-infrared and suitable for implementation of the invention. A second component, intended to form a source pulse IL2, undergoes spectral broadening by propagation through a non-linear medium MNL followed by optical compression in a dispersive delay line LRD—see for example (Nisoli 1998)—in order to reduce its duration to a few optical cycles, or even ideally to a single optical cycle. The dispersive delay line LRD also allows the delay Δt between the generator pulse and the source pulse to be adjusted (as a variant, a separate delay line may be used).

Generation of the generator and source pulses from the same laser oscillator is a preferred feature of the invention, even though it is not essential. Specifically, the delay Δt between the two pulses must be controlled with a precision of the order of a fraction of T₂, i.e. of a few femtoseconds or less. This can be achieved without particular difficulty using a conventional delay line, but it would be much more difficult to synchronize two separate laser sources with such precision.

The optical system SO recombines the pulses IL1 and IL2 so as to make them collinear and to focus them on or in proximity to the target. In its simplest form, it may comprise two concave mirrors, M1 and M2, one (M2) of which has a hole at its center.

In general, the generator pulse must be strongly focused—ideally at close to the diffraction limit—to allow it to reach relativistic intensities. In contrast, it is not necessary to strongly focus the source pulse: on the contrary, it is preferable not to do so to prevent it from disturbing the dynamics of the plasma mirror, which ideally should be controlled exclusively by the generator pulse. Furthermore, the larger the spot formed by the beam IL2 on the plasma mirror-without exceeding the dimensions of the mirror itself, which are defined by the spot formed by the beam IL1 on the target—the larger the waist of the reflected pulse IR2 will be and the more it will be collimated, this allowing it to be focused effectively.

The laser system may be more complex than the one shown in [FIG. 5]. For example, it may also comprise a device for controlling the polarization of the source pulse, such as a birefringent plate or a series of such plates. Specifically, the polarization of the source pulse has little influence on conversion efficiency and it is transmitted to the reflected pulse. This makes it possible, for example, to obtain an EUV pulse of arbitrary (e.g. elliptical or circular) polarization simply by changing the polarization of the source pulse, this being very difficult, or even impossible, with known prior-art techniques using a single generator beam (with which the efficiency of generation of EUV/X-rays depends strongly on the polarization of this beam). Furthermore, it may be useful to rotate the polarization plane of the source pulse so that it is “s” polarized on the target. This makes it possible to prevent a component of the electric field of the source pulse from lying normal to the target and thus to minimize the impact of said pulse on the dynamics of the plasma mirror.

The laser system may also comprise a pulse-shaping system (for example, an acousto-optic modulator) in order to control the temporal shape of the EUV pulse. As with polarization, the temporal shape of the source pulse has no influence on conversion efficiency and is therefore transmitted to the reflected pulse. It is very difficult, or even impossible, to shape EUV pulses temporally with known prior-art techniques.

According to one preferred embodiment of the invention, the laser oscillator OL may be an ytterbium laser, which delivers pulses of very high energies (from a few hundred mJ to a few J) and of typical durations of the order of a few hundred fs to a few tens of ps with a wavelength of 2.5 μm. Most of this energy, typically about 90%, is directed to an OPCPA—such as the one described in (von Grafenstein 2020) cited above—which converts pulses in the wavelength range from 3 to 10 μm (mid-infrared). With a conversion efficiency of up to 6-7%, it may be expected to obtain pulses in the mid-infrared of a few tens to a few hundred mJ and of a few optical cycles, with durations typically of the order of tens to a few hundred optical cycles. These pulses are sufficiently intense to be able to generate relativistic plasma mirrors. The rest of the energy of the ytterbium laser, typically about 10%, is compressed in a non-linear medium such as a gas cell, a hollow fiber or a thin plate to obtain a pulse at 1 μm of 1 to 2 optical cycles of a few mJ to a few hundred mJ that are synchronized with the pulse in the mid-infrared. Reflection by the plasma mirror generated by the latter pulse converts a large part of the source pulse at 1% into the UV/EUV in the form of a single attosecond pulse.

A plurality of variants of this scheme are envisionable.

First of all, beforehand the source pulse may be frequency doubled to 500 nm (or even frequency tripled or indeed quadrupled) then compressed to a few cycles. This makes it possible not to have to generate a pulse of 1-2 optical cycles as at 1 μm but of 2-4 optical cycles at 500 nm.

Instead of using an ytterbium laser, a 2 μm holmium laser could for example be envisioned. Its main advantage is that pulses in the mid-infrared may be derived from it with a very high conversion rate (greater than 10%). The source pulse may be compressed to 1-2 optical cycles while keeping its central wavelength at 2 μm or be doubled to 1 μm beforehand.

According to another embodiment, the laser oscillator OL may be a Ti: sapphire oscillator emitting at 800 nm. Ti: sapphire lasers are the ones that, at the present time, produce the most powerful light pulses, reaching several petawatts (PW), with energies of a few hundred J for durations of the order of 10 fs. As in the preceding case, an OPCPA may be used to generate a generator pulse in the mid-infrared with an efficiency of the order of a few percent. Thus, an initial pulse of 10 J at 800 nm may for example be converted into a generator pulse of 100 mJ at 10 μm. In parallel, a smaller part of the energy of the 800 nm pulse (a few tens of mJ or a few hundred mJ) may be compressed to a duration of one to a few optical cycles. This makes it possible to obtain, after reflection from the plasma mirror, EUV pulses of a few tens of to a few hundred mJ.

As above, the compressed pulses may be frequency doubled to 400 nm beforehand, to increase the wavelength difference between the generator pulse and the source pulse.

In another embodiment, the high-energy pulse at 800 nm (up to a few kJ) generated by a Ti: sapphire laser may be used directly as generator pulse. The source pulse may be obtained by frequency conversion to the harmonic of order 3 or 4 of the initial pulse at 800 nm (i.e. to 266 or 200 nm), spectrally broadened then compressed.

In addition to being able to reach very short DUV/EUV wavelengths, the technique of the invention in fact allows the wavelength of the reflected pulse to be adjusted (or “tuned”) very simply by varying the amplitude and sign of the velocity of the mirror at the time of reflection. These two physical quantities vary during an optical cycle of the generator pulse

In each optical cycle of the generator pulse, the plasma mirror is first pushed toward the target then pulled toward free space. If the source pulse is reflected when the mirror is being pulled toward free space (negative velocity), it will be “blue” shifted. If the source pulse is reflected when the mirror is being pushed toward the target, it will be “red” shifted. Several parameters in practice allow the amplitude and sign of the velocity of the mirror to be controlled:

The delay between the generator pulse and the source pulse. This delay makes it possible to control the time at which the source pulse is reflected from the plasma mirror, and thus the amplitude and sign of the velocity of the mirror at that time.

The CEP of the generator pulse. Changing the CEP allows the time at which the plasma mirror is pulled toward free space to be changed. This has an effect equivalent to changing the delay.

The amplitude of the generator pulse, which may be increased or decreased by acting on the energy of this pulse or on the size of its focal spot. Increasing the amplitude of the laser field of the generator pulse increases the amplitude of the velocity of the mirror, and thus the magnitude of the blue or red shift experienced by the source pulse.

The source and generator pulses need not propagate collinearly, their propagation directions being able to make an angle strictly smaller than 180°—preferably smaller than 90° and also preferably not larger than 10°—with a view to spatially separating the pulses after interaction.

So far, only the case where the source pulse is reflected while the plasma mirror is moving toward free space (away from the target), and therefore undergoes a blue shift and temporal compression, has been considered. However, the invention is not limited to this case. For example, it is possible to adjust the delay Δt and/or CEP such that the source pulse is reflected while the plasma mirror is moving toward the target. This results in a red shift of the reflected pulse, to the THz domain. In particular, it will be possible to obtain THz pulses with durations shorter than the optical cycle. There are a number of methods for generating such THz pulses, but the invention allows unparalleled energies to be achieved.

Moreover, it is also possible to make it so that the rising edge of the source pulse is reflected while the plasma mirror is moving away from the target and its falling edge is reflected when the mirror is moving closer thereto, or vice versa. Under these conditions, the source pulse undergoes both a blue shift and a red shift. The result is a reflected pulse that has an extremely broad spectrum, which may extend over a high number of octaves (for example from 20 nm to 20 μm, or 10 octaves). Such pulses cannot be generated by any known prior-art technique.

### BIBLIOGRAPHIC REFERENCES

(Vincenti 2019): H. Vincenti “Achieving Extreme Light Intensities using Optically Curved Relativistic Plasma Mirrors” Physical Review Letters 123, 105001 (2019).
(Bulanov 2003): S. V. Bulanov, T. Esirkepov and T. Tajima, “Light Intensification towards the Schwinger Limit” Phys. Rev. Lett., vol. 91, no. 8, p. 085001, August 2003.
(Tamburini 2014): M. Tamburini, A. Di Piazza, T. V. Liseykina, and C. H. Keitel, “Plasma-Based Generation and Control of a Single Few-Cycle High-Energy Ultrahigh-Intensity Laser Pulse” Phys. Rev. Lett., vol. 113, no. 2, p. 025005, July 2014.
(von Grefenstein 2020): L. von Grefenstein et al. “Multi-millijoule, few-cycle 5 μm OPCPA at 1 kHz repetition rate”, Optics Letters, vol. 45, no. 21, p. 5998 Nov. 2020.
(Nisoli 1998): M. Nisoli et al. “Toward a Terawatt-Scale Sub-10-fs Laser Technology”, IEEE Journal of Selected Topics in Quantum Electronics, vol. 4, no. 2, p. 414, March-April 1998.

1. A method for generating isolated ultra-short electromagnetic pulses of duration shorter than 100 ps (IR2), comprising the following steps:
directing onto a surface (SC) of a target (CEC) in the condensed state a first laser pulse (IL1) at an oblique angle of incidence and with p-polarization, said first laser pulse having a first wavelength (2), corresponding to a first optical period (T1), and a normalized peak amplitude greater than or equal to 1, whereby a plasma mirror (MPR) oscillating at relativistic velocity is generated on the surface of the target; and
directing onto said surface of the target, in correspondence with said plasma mirror, a second laser pulse (IL2) having a second wavelength, shorter than the first wavelength, and a duration (τ₂) shorter than or equal to the first optical period (T1), the second laser pulse being spatially and temporally superposed with the first laser pulse; whereby the second laser pulse, reflected by the plasma mirror, undergoes a shift of its wavelength and a modification of its duration.

2. The method as claimed in claim 1, wherein the duration (τ₂) of the second laser pulse (IL2) is shorter than or equal to half the first optical period, the temporal shift between the first and second laser pulses being chosen such that, throughout the duration for which the second laser pulse is incident on the plasma mirror (MPR), the latter moves away from the surface of the target, whereby the second laser pulse (IL2) undergoes a blue shift of its wavelength and temporal compression via the Doppler effect.

3. The method as claimed in claim 1, wherein the second laser pulse (IL2) propagates in a direction (DPI) collinear with a direction of propagation of the first laser pulse.

4. The method as claimed in claim 1, wherein the first laser pulse (IL1) is incident on the surface of the target with an angle of incidence (0i) between 25° and 75°.

5. The method as claimed in claim 1, wherein the second laser pulse (IL2) has, on the surface of the target, a normalized peak amplitude less than that of the first laser pulse (IL1).

6. The method as claimed in claim 1, wherein the second laser pulse (IL2) is incident on the surface of the target with s-polarization.

7. The method as claimed in claim 1, comprising a step (CEP) of stabilizing the phase of the carrier of the first laser pulse (IL1) relative to its envelope.

8. The method as claimed in claim 1, comprising a step of controlling the shift of the wavelength of the second laser pulse reflected by the plasma mirror by adjusting at least one parameter chosen from: a phase (CEP) of the carrier of the first laser pulse relative to its envelope; a delay (Δt) between the first and second laser pulses; a peak amplitude of the first laser pulse.

9. The method as claimed in claim 1, comprising a prior step of generating the first and second laser pulses from the same laser pulse, which is called the initial laser pulse (ILI).

10. The method as claimed in claim 9, wherein said initial laser pulse (ILI) is a pulse in the near infrared, said prior step comprising:
wavelength conversion of a majority fraction of the initial laser pulse to the mid-infrared by an optical parametric amplifier (OPCPA); and
spectral broadening of a minority fraction of the initial laser pulse by propagation through an optically non-linear medium (MNL) and its temporal compression via a dispersive delay line (LRD).

11. The method as claimed in claim 1, comprising a prior step of shaping the temporal intensity and/or polarization profile of the second laser pulse.

12. An apparatus for generating isolated ultra-short electromagnetic pulses of duration shorter than 100 ps, comprising:
a laser system (SL) configured to generate a first laser pulse (IL1) having a first wavelength (λ₁) corresponding to a first optical period (T1) and a second laser pulse (IL2) having a second wavelength, shorter than the first wavelength, and a duration shorter than or equal to the first optical period;
an optical system configured to:
direct onto a surface (SC) of a target (CEC) in the condensed state the first laser pulse (IL1), at an oblique angle of incidence and with a p-polarization;
direct onto said surface of the target the second laser pulse (IL2), such that it is spatially and temporally superposed with the first laser pulse;
the laser system and the optical system also being configured such that the first laser pulse has, on the surface of the target, a normalized peak amplitude greater than or equal to 1.
